(19) United States
(12) Patent Application Publication
(10) Pub. No.: US 2026/0023264 A1
(43) Pub. Date: Jan. 22, 2026

(54) ACTIVE POLARIZATION SWITCHES FOR A HEAD-MOUNTED DISPLAY

(71) Applicant: Valve Corporation, Bellevue, WA (US)

(72) Inventors: Joshua Hudman, Bellevue, WA (US); Kameron Wade Rausch, Sammamish, WA (US)

(21) Appl. No.: 19/269,453

(22) Filed: Jul. 15, 2025

Related U.S. Application Data
(60) Provisional application No. 63/672,154, filed on Jul. 16, 2024.

(51) Int. Cl. G02B 27/01; G02F 1/1335

(52) U.S. Cl. CPC G02B 27/0172; G02F 1/133526; G02B 2027/0138

(57) ABSTRACT

Light from a display device is optically shifted to increase an effective resolution of the display device and/or to decrease pixel structure artifacts. Without limitation, optical shifting can be performed using a birefringent element or an element with a varying refractive index. The optical shifter can electronically controlled to toggle between shifting light and letting light pass through the optical shifter without being shifted.

### CROSS-REFERENCE TO RELATED APPLICATIONS

This application claims the benefit of U.S. Provisional Patent Application No. 63/672,154, filed Jul. 16, 2024, the entire contents of which are hereby incorporated by reference for all purposes in its entirety.

### BACKGROUND

The following disclosure generally relates to head-mounted displays. A head-mounted display (HMD) is an electronic device or system worn on a user's head and, when worn, secures at least one electronic display within a viewable field of at least one of the user's eyes, regardless of a position or orientation of the user's head. An HMD used to implement virtual reality (VR) typically envelop a wearer's eyes completely and substitute a “virtual” reality for an actual view (or actual reality) in front of the user. An HMD for augmented reality (AR) can provide a semi-transparent or transparent overlay of one or more screens in front of a wearer's eyes such that an actual view is augmented with additional information. In some AR devices, the “display” component of an HMD can be transparent or at a periphery of the user's field of view so that it does not completely block the user from being able to see their external environment. In some AR devices, a display overlays digital content on a video feed from a camera acquiring images of a real scene. Mixed Reality (MR) is an interaction between a digital and the physical world. Extended Reality (ER) can be used to refer to VR, AR, and/or MR.

### BRIEF SUMMARY

Without limitation, this disclosure generally relates to increasing effective resolution of a display.

In some configurations, an apparatus for a head-mounted display comprises: a display device; a lens assembly for a head-mounted display, the lens assembly arranged to focus light from the display device to an eye of a user of the head-mounted display; a birefringent element between the display device and the lens assembly; and/or a half waveplate between the birefringent element and the lens assembly, wherein the half waveplate and the birefringent element are arranged to shift light from the display device by a distance equal to or greater than ⅕ of a pixel spacing in the display device and equal to or less than 5/4 of the pixel spacing. In some configurations, the half waveplate is disposed on the birefringent element; shifting light is arranged to reduce column artifacts of the display devices; the display device is a screen; and/or the display device is a projector.

In some configurations, an apparatus comprises: a display device; a lens assembly arranged to focus light from the display device to an eye of a user of the head-mounted display; and/or an optical component arranged to shift light from the display device by a distance equal to or greater than ⅕ of a pixel spacing in the display device and equal to or less than 5/4 of the pixel spacing. In some configurations, the display device is a display panel or a projector; the optical component comprises a birefringent element; the optical component comprises an electronically activated optical retarder and a birefringent element between the optical retarder and the lens assembly; the optical retarder is a half waveplate; the optical component is electronically controlled; the optical component is synced with the display device and/or activates every other frame of the display device; the optical component is optically between the display device and the lens assembly; the display device is a projector and the lens assembly is optically between the display device and the optical component; the optical component comprises an adaptive molecular optic; the optical component comprises a liquid crystal controllable lens; the distance shifted is at a 45-degree angle, plus or minus 10 degrees, with respect to a horizontal dimension of the display device; a rendering camera angle is shifted in synchronization with shifting light from the display device; shifting light from the display by the optical component is arranged to wash out visibility of pixel structure, improve a fill factor of pixels, reduce mura, and/or reduce the column artifacts of the display device; the birefringent element has a variable refractive index.

In some configurations, a method comprises transmitting light from a display device to a lens assembly for a head-mounted display, the lens assembly arranged to focus light from the display device to an eye of a user of the head-mounted display; transmitting light through an optical shifter; shifting light from the display device, using the optical shifter, by a distance equal to or greater than ⅕ of a pixel spacing in the display device and equal to or less than 5/4 of the pixel spacing; and/or switching the optical shifter so that the optical shifter does not shift light so that light passes through the optical shifter without deviation. In some configurations, the optical shifter is between the display device and the lens assembly; the lens assembly is between the display device and the optical shifter; light passes through the optical shifter without deviation; and/or light is transmitted though the optical shifter by light passing through a first half waveplate, then through a second halfwave plate, and then through a second half waveplate.

In some configurations, a method for synchronizing camera angle with pixel shift comprises transmitting light from a display to an optical shifter; light transmitted through the optical shifter is toggled between a first path and a second path; and/or a rendering camera angle is toggled synchronously with toggling light transmitted through the optical shifter.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures.

FIG. 1 is a schematic diagram of an embodiment of a networked environment of a head-mounted display (HMD).

FIG. 2 is a diagram illustrating an embodiment of an environment for using an HMD.

FIG. 3 is a front pictorial diagram of an embodiment of an HMD having binocular display subsystems.

FIG. 4 illustrates a top plan view of an embodiment of an HMD having binocular display subsystems and various sensors.

FIG. 5 depicts an embodiment of a system with an optical component for shifting light from a display.

FIG. 6 depicts an embodiment of an optical component with a birefringent element for shifting light from a display.

FIG. 7 depicts an embodiment of a system with an optical component having a variable refractive index.

FIG. 8 depicts an embodiment of a process for using an optical shifter.

FIG. 9 depicts an embodiment of a process for toggling a rendering camera angle with the optical shifter.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Increasing resolution in displays is becoming increasingly difficult. Some embodiments relate to shifting light to increase an effective resolution of a display and/or decrease pixel structure artifacts.

For illustrative purposes, some embodiments are described below in which specific types of information are acquired and used in specific types of ways for specific types of structures and by using specific types of devices. However, it will be understood that such described techniques may be used in other manners in other embodiments, and that the present disclosure is thus not limited to the exemplary details provided. As a non-exclusive example, some embodiments include the use of images that are video frames. While an example may refer to a “video frame” for convenience, it will be appreciated that the techniques described with the example may be employed with respect to one or more images of various types, including non-exclusive examples of multiple video frames in succession (e.g., at 30, 60, 90, 180 or some other quantity of frames per second), other video content, photographs, computer-generated graphical content, other articles of visual media, or some combination thereof. Additionally, various details are provided in the drawings and text for exemplary purposes and are not intended to limit the scope of the present disclosure.

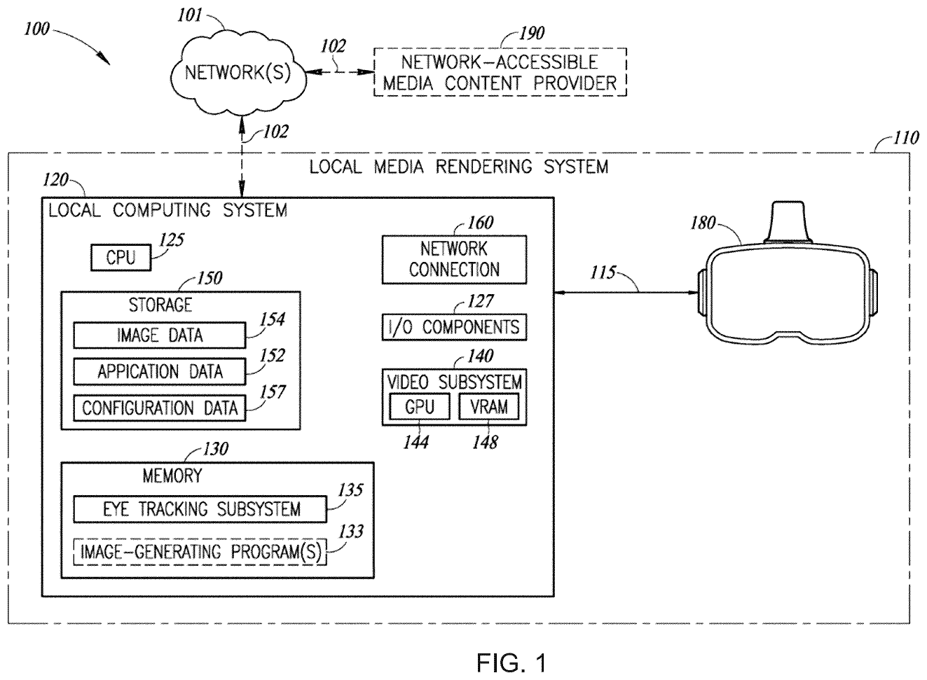

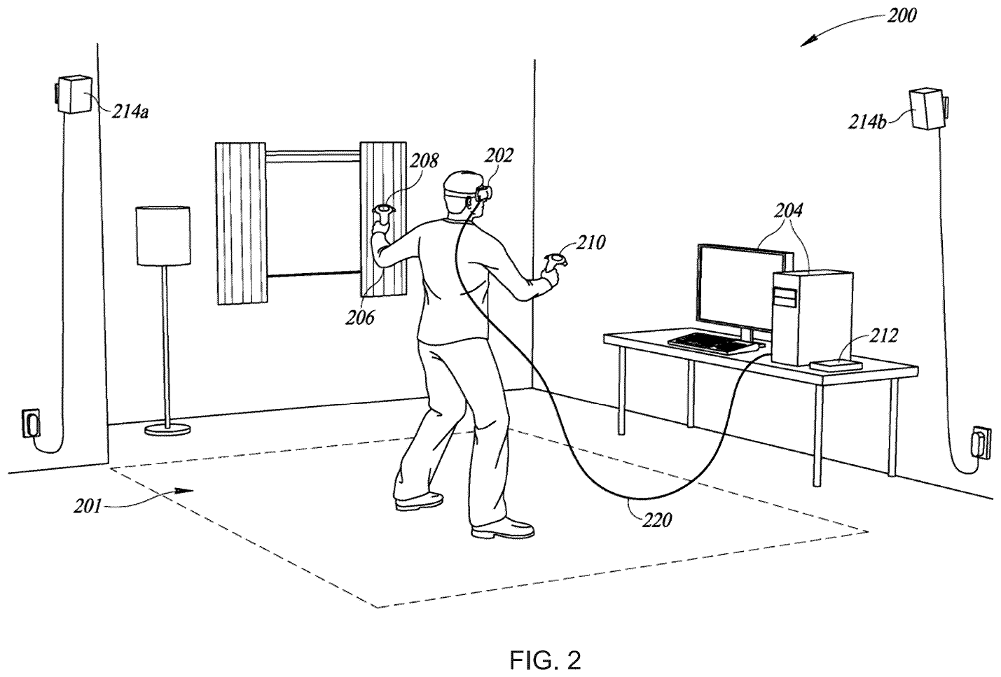

FIG. 1 is a schematic diagram of an embodiment of a networked environment 100. The networked environment 100 includes a local media rendering (LMR) system 110 (e.g., a gaming system), which includes a local computing system 120 and display device 180 (e.g., an HMD device with two display panels). In FIG. 1, the local computing system 120 is communicatively connected to display device 180 via transmission link 115 (which may be wired or tethered, such as via one or more cables as illustrated in FIG. 2 (cable 220), or instead may be wireless). In some embodiments, the local computing system 120 may provide encoded image data for display to a panel display device (e.g., a TV, console or monitor) via a wired or wireless link, whether in addition to or instead of the HMD device 180, and the display devices each includes one or more addressable pixel arrays. In some embodiments, the local computing system 120 may include a general purpose computing system; a gaming console; a video stream processing device; a mobile computing device (e.g., a cellular telephone, PDA, or other mobile device); a VR or AR processing device; or other computing system.

A pixel is the smallest addressable image element of a display that may be activated to provide a color value. In some cases, a pixel includes individual respective sub-elements (in some cases as separate “sub-pixels”) for separately producing red, green, and blue light for perception by a human viewer, with separate color channels used to encode pixel values for the sub-pixels of different colors. A pixel value refers to a data value corresponding to respective levels of stimulation for one or more of respective RGB elements of a single pixel.

In FIG. 1, the local computing system 120 has components that include one or more hardware processors (e.g., centralized processing units, or “CPUs”) 125, memory 130, various I/O (“input/output”) hardware components 127 (e.g., a keyboard, a mouse, one or more gaming controllers, speakers, microphone, IR transmitter and/or receiver, etc.), a video subsystem 140 that includes one or more specialized hardware processors (e.g., graphics processing units, or “GPUs”) 144 and video memory (VRAM) 148, computer-readable storage 150, and a network connection 160. An embodiment of an eye tracking subsystem 135 executes in memory 130 in order to perform one or more processes, such as by using the CPU(s) 125 and/or GPU(s) 144 to perform automated operations. The memory 130 may optionally further execute one or more other programs 133 (e.g., to generate video or other images to be displayed, such as a game program). As part of the automated operations, the eye tracking subsystem 135 and/or programs 133 executing in memory 130 may store or retrieve various types of data, including in the example database data structures of storage 150, in this example, the data used may include various types of image data information in database (“DB”) 154, various types of application data in DB 152, various types of configuration data in DB 157, and may include additional information, such as system data or other information.

The LMR system 110 is communicatively connected via one or more computer networks 101 and network links 102 to an exemplary network-accessible media content provider 190 that may further provide content to the LMR system 110 for display, whether in addition to or instead of the image-generating programs 133. The media content provider 190 may include one or more computing systems (not shown) that may each have components similar to those of local computing system 120, including one or more hardware processors, I/O components, local storage devices and memory, although some details are not illustrated for the network-accessible media content provider for the sake of brevity.

It will be appreciated that, while the display device 180 is depicted as being distinct and separate from the local computing system 120 in FIG. 1, in some embodiments, some or all components of the local media rendering system 110 may be integrated or housed within a single device, such as a mobile gaming device, portable VR entertainment system, HMD device, etc. In some embodiments, transmission link 115 may, for example, include one or more system buses and/or video bus architectures.

As one example involving operations performed locally by the local media rendering system 120, assume that the local computing system is a gaming computing system, such that application data 152 includes one or more gaming applications executed via CPU 125 using memory 130, and that various video frame display data is generated and/or processed by the image-generating programs 133, such as in conjunction with GPU 144 of the video subsystem 140. In order to provide a quality gaming experience, a high volume of video frame data (corresponding to high image resolution for each video frame, as well as a high “frame rate” of approximately 60-180 of such video frames per second) is generated by the local computing system 120 and provided via the wired or wireless transmission link 115 to the display device 180.

It will also be appreciated that computing system 120 and display device 180 are merely illustrative and are not intended to limit the scope of the present disclosure. The computing system 120 may instead include multiple interacting computing systems or devices, and may be connected to other devices that are not illustrated, including through one or more networks such as the Internet, via the Web, or via private networks (e.g., mobile communication networks, etc.). More generally, a computing system or other computing node may include any combination of hardware or software that may interact and perform the described types of functionality, including, without limitation, desktop or other computers, game systems, database servers, network storage devices and other network devices, PDAs, cell phones, wireless phones, pagers, electronic organizers, Internet appliances, television-based systems (e.g., using set-top boxes and/or personal/digital video recorders), and various other consumer products that include appropriate communication capabilities. The display device 180 may similarly include one or more devices with one or more display panels of various types and forms, and optionally include various other hardware and/or software components.

In addition, the functionality provided by the eye tracking subsystem 135 may, in some embodiments, be distributed in one or more components, and in some embodiments some of the functionality of the eye tracking subsystem 135 may not be provided and/or other additional functionality may be available. It will also be appreciated that, while various items are illustrated as being stored in memory or on storage while being used, these items or portions of them may be transferred between memory and other storage devices for purposes of memory management or data integrity. Thus, in some embodiments, techniques may be performed by hardware that include one or more processors or other configured hardware circuitry or memory or storage, such as when configured by one or more software programs (e.g., by the eye tracking subsystem 135 or it components) and/or data structures (e.g., by execution of software instructions of the one or more software programs and/or by storage of such software instructions and/or data structures). Some or all of the components, systems, and/or data structures may be stored (e.g., as software instructions or structured data) on a non-transitory computer-readable storage medium, such as a hard disk or flash drive or other non-volatile storage device, volatile or non-volatile memory (e.g., RAM), a network storage device, or a portable media article to be read by an appropriate drive (e.g., a DVD disk, a CD disk, an optical disk, etc.) or via an appropriate connection. The systems, components and data structures may also in some embodiments be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in some embodiments.

FIG. 2 illustrates an embodiment of an environment 200 used with an example HMD device 202 that is coupled to a video rendering computing system 204 via a tethered connection 220 (or a wireless connection in some embodiments) to provide a virtual reality display to a human user 206. The user wears the HMD device 202 and receives displayed information via the HMD device from the computing system 204 of a simulated environment different from the actual physical environment, with the computing system acting as an image rendering system that supplies images of the simulated environment to the HMD device for display to the user, such as images generated by a game program and/or other software program executing on the computing system. The user is further able to move around within a tracked volume 201 of the actual physical environment 200 in this example, and may further have one or more I/O (“input/output”) devices to allow the user to further interact with the simulated environment, which in this example includes hand-held controllers 208 and 210.

In the illustrated example, the environment 200 may include one or more base stations 214 (two shown, labeled base stations 214-a and 214-b) that may facilitate tracking of the HMD device 202 or the controllers 208 and 210. As the user moves location or changes orientation of the HMD device 202, the position of the HMD device is tracked, such as to allow a corresponding portion of the simulated environment to be displayed to the user on the HMD device, and the controllers 208 and 210 may further employ similar techniques to use in tracking the positions of the controllers (and to optionally use that information to assist in determining or verifying the position of the HMD device). After the tracked position of the HMD device 202 is known, corresponding information is transmitted to the computing system 204 via the tether 220 or wirelessly, which uses the tracked position information to generate one or more next images of the simulated environment to display to the user.

There are numerous methods of positional tracking that may be used in the various implementations of the present disclosure, including, but not limited to, acoustic tracking, inertial tracking, magnetic tracking, optical tracking, combinations thereof, etc.

In some implementations, the HMD device 202 includes one or more optical receivers or sensors that may be used to implement tracking functionality or other aspects of the present disclosure. For example, the base stations 214 may each sweep an optical signal across the tracked volume 201. Depending on the requirements of each particular implementation, each base station 214 may generate more than one optical signal. For example, while a single base station 214 can be sufficient for six-degree-of-freedom tracking, multiple base stations (e.g., base stations 214 a, 214 b) may be used in some embodiments to provide robust room-scale tracking for HMD devices and/or peripherals. In this example, optical receivers are incorporated into the HMD device 202 and or other tracked objects, such as the controllers 208 and 210. In some embodiments, optical receivers may be paired with an accelerometer and gyroscope Inertial Measurement Unit (“IMU”) on each tracked device to support low-latency sensor fusion.

In some implementations, each base station 214 includes two rotors that sweep a linear beam across the tracked volume 201 on orthogonal axes. At the start of each sweep cycle, the base station 214 may emit an omni-directional light pulse (referred to as a “sync signal”) that is visible to sensors on the tracked objects. Thus, each sensor computes a unique angular location in the swept volume by timing the duration between the sync signal and the beam signal. Sensor distance and orientation may be solved using multiple sensors affixed to a single rigid body.

The one or more sensors positioned on the tracked objects (e.g., HMD device 202, controllers 208 and 210) may comprise an optoelectronic device capable of detecting the modulated light from the rotor. For visible or near-infrared (NIR) light, silicon photodiodes and suitable amplifier/detector circuitry may be used. Because the environment 200 may contain static and time-varying signals (optical noise) with similar wavelengths to the signals of the base stations 214 signals, in some implementations the base station light may be modulated in such a way as to make it easy to differentiate from any interfering signals, and/or to filter the sensor from any wavelength of radiation other than that of base station signals.

Inside-out tracking is also a type positional tracking that may be used to track the position of the HMD device 202 and/or other objects (e.g., controllers 208 and 210, tablet computers, smartphones). Inside-out tracking differs from outside-in tracking by the location of the cameras or other sensors used to determine the HMD's position. For inside-out tracking, the camera or sensors are located on the HMD, or object being tracked, while in outside-out tracking the camera or sensors are placed in a stationary location in the environment.

An HMD that utilizes inside-out tracking utilizes one or more cameras to “look out” to determine how its position changes in relation to the environment. When the HMD moves, the sensors readjust their place in the room and the virtual environment responds accordingly in real-time. This type of positional tracking can be achieved with or without markers placed in the environment. The cameras that are placed on the HMD observe features of the surrounding environment. When using markers, the markers are designed to be easily detected by the tracking system and placed in a specific area. With “markerless” inside-out tracking, the HMD system uses distinctive characteristics (e.g., natural features) that originally exist in the environment to determine position and orientation. The HMD system's algorithms identify specific images or shapes and use them to calculate the device's position in space. Data from accelerometers and gyroscopes can also be used to increase the precision of positional tracking.

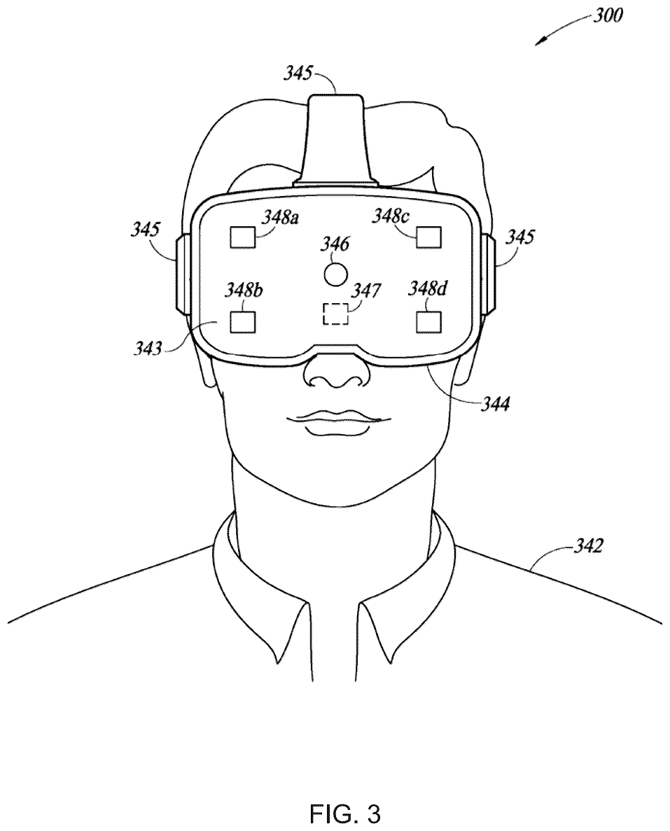

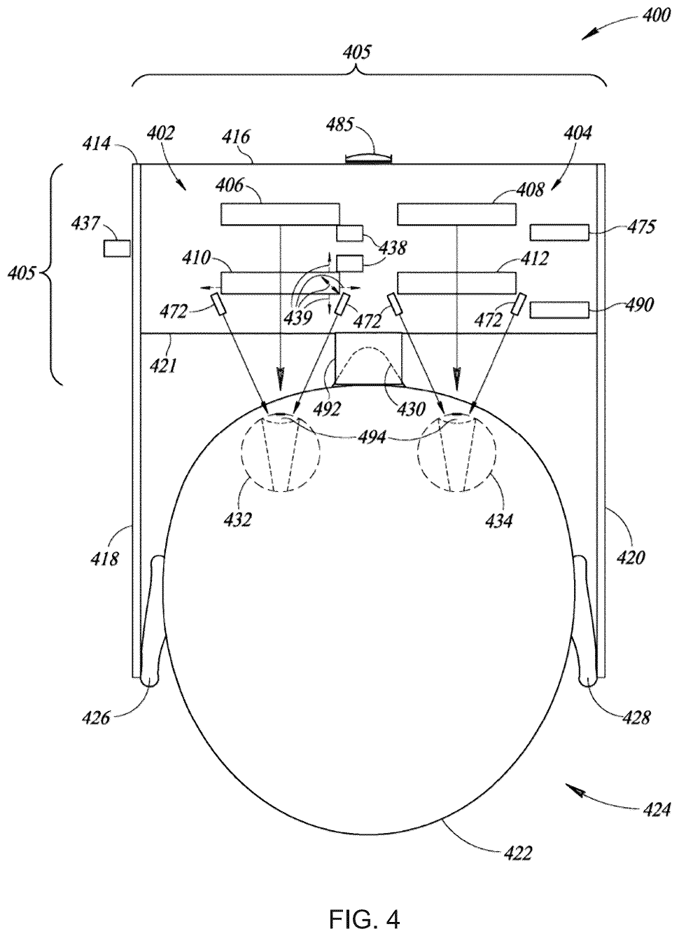

FIG. 3 shows information 300 illustrating a front view of an example HMD device 344 when worn on the head of a user 342. The HMD device 344 includes a front-facing structure 343 that supports a front-facing or forward camera 346 and a plurality of sensors 348 a-348 d (collectively 348) of one or more types. As one example, some or all of the sensors 348 may assist in determining the location and/or orientation of the device 344 in space, such as light sensors to detect and use light information emitted from one or more external devices (not shown, e.g., base stations 214 of FIG. 2). As shown, the forward camera 346 and the sensors 348 are directed forward toward an actual scene or environment (not shown) in which the user 342 operates the HMD device 344. The actual physical environment may include, for example, one or more objects (e.g., walls, ceilings, furniture, stairs, cars, trees, tracking markers, or any other types of objects). The particular number of sensors 348 may be fewer or more than the number of sensors depicted. The HMD device 344 may further include one or more additional components that are not attached to the front-facing structure (e.g., are internal to the HMD device), such as an IMU (inertial measurement unit) 34π electronic device that measures and reports the HMD device's 344 specific force, angular rate, and/or the magnetic field surrounding the HMD device (e.g., using a combination of accelerometers and gyroscopes, and optionally, magnetometers). The HMD device may further include additional components that are not shown, including one or more display panels and optical lens systems that are oriented toward eyes (not shown) of the user and that optionally have one or more attached internal motors to change the alignment or other positioning of one or more of the optical lens systems and/or display panels within the HMD device, as discussed in greater detail below with respect to FIG. 4.

The illustrated example of the HMD device 344 is supported on the head of user 342 based at least in part on one or more straps 345 that are attached to the housing of the HMD device 344 and that extend wholly or partially around the user's head. While not illustrated here, the HMD device 344 may further have one or more external motors, such as attached to one or more of the straps 345, and automated corrective actions may include using such motors to adjust such straps in order to modify the alignment or other positioning of the HMD device on the head of the user. It will be appreciated that HMD devices may include other support structures that are not illustrated here (e.g., a nose piece, chin strap, etc.), whether in addition to or instead of the illustrated straps, and that some embodiments may include motors attached one or more such other support structures to similarly adjust their shape and/or locations to modify the alignment or other positioning of the HMD device on the head of the user. Other display devices that are not affixed to the head of a user may similarly be attached to or part of one or structures that affect the positioning of the display device, and may include motors or other mechanical actuators some embodiments to similarly modify their shape and/or locations to modify the alignment or other positioning of the display device relative to one or more pupils of one or more users of the display device.

FIG. 4 illustrates a simplified top plan view 400 of an embodiment of an HMD device 405 that includes a pair of near-to-eye display systems 402 and 404. The HMD device 405 may, for example, be the same or similar HMD devices illustrated in FIGS. 1-3 or a different HMD device, and the HMD devices discussed herein may further be used in the examples discussed further below. The near-to-eye display systems 402 and 404 of FIG. 4 include display panels 406 and 408, respectively (e.g., OLED micro-displays), and respective optical lens systems 410 and 412 that each have one or more optical lenses. The display systems 402 and 404 may be mounted to or otherwise positioned within a housing (or frame) 414, which includes a front-facing portion 416 (e.g., the same or similar to the front-facing surface 343 of FIG. 3), a left temple 418, right temple 420 and interior surface 421 that touches or is proximate to a face of a wearer user 424 when the HMD device is worn by the user. The two display systems 402 and 404 may be secured to the housing 414 in an eye glasses arrangement which can be worn on the head 422 of a wearer user 424, with the left temple 418 and right temple 420 resting over the user's cars 426 and 428, respectively, while a nose assembly 492 may rest over the user's nose 430. In the example of FIG. 4, the HMD device 405 may be supported on the head of the user in part or in whole by the nose display and/or the right and left over-ear temples, although straps (not shown) or other structures may be used in some embodiments to secure the HMD device to the head of the user, such as the embodiments shown in FIGS. 2 and 3. The housing 414 may be shaped and sized to position each of the two optical lens systems 410 and 412 in front of one of the user's eyes 432 and 434, respectively, such that a target location of each pupil 494 is centered vertically and horizontally in front of the respective optical lens systems and/or display panels. Although the housing 414 is shown in a simplified manner similar to eyeglasses for explanatory purposes, it should be appreciated that in practice more sophisticated structures (e.g., goggles, integrated headband, helmet, straps, etc.) may be used to support and position the display systems 402 and 404 on the head 422 of user 424.

The HMD device 405 of FIG. 4 is arranged to present a virtual reality display to the user, such as via corresponding video presented at a display rate such as 30 or 60 or 90 frames (or images) per second. In some embodiments, the HMD device may present an augmented reality display to the user. Each of the displays 406 and 408 of FIG. 4 may generate light which is transmitted through and focused by the respective optical lens systems 410 and 412 onto the eyes 432 and 434, respectively, of the user 424. The pupil 494 aperture of each eye, through which light passes into the eye, will generally have a pupil size ranging from 2 mm (millimeters) in diameter in very bright conditions to as much as 8 mm in dark conditions, while the larger iris in which the pupil is contained may have a size of approximately 12 mm—the pupil (and enclosing iris) may further move within the visible portion of the eye under open eyelids by several millimeters in the horizontal and/or vertical directions, which will also move the pupil to different depths from the optical lens or other physical elements of the display for different horizontal and vertical positions as the eyeball swivels around its center (resulting in a three dimensional volume in which the pupil can move). The light entering the user's pupils is seen by the user 424 as images and/or video. In some implementations, the distance between each of the optical lens systems 410 and 412 and the user's eyes 432 and 434 may be relatively short (e.g., less than 30 mm, less than 20 mm), which advantageously causes the HMD device to appear lighter to the user since the weight of the optical lens systems and the display systems are relatively close to the user's face, and also may provide the user with a greater field of view. Some embodiments of an HMD device may include various additional internal and/or external sensors.

In FIG. 4, the HMD device 405 includes hardware sensors and additional components, such as to include one or more accelerometers and/or gyroscopes 490 (e.g., as part of one or more IMU units). Values from the accelerometer(s) and/or gyroscopes may be used to locally determine an orientation of the HMD device. In addition, the HMD device 405 may include one or more front-facing cameras, such as camera(s) 485 on the exterior of the front portion 416, and whose information may be used as part of operations of the HMD device, such as for providing AR functionality or positioning functionality. Furthermore, the HMD device 405 may further include other components 475 (e.g., electronic circuits to control display of images on the display panels 406 and 408, internal storage, one or more batteries, position tracking devices to interact with external base stations, etc.). Some embodiments may not include one or more of the components 475, 485 and/or 490. Some embodiments of an HMD device may include various additional internal and/or external sensors, such as to track various other types of movements and position of the user's body, eyes, controllers, etc.

The HMD device 405 further includes hardware sensors and additional components that may be used for determining user pupil or gaze direction, which may be provided to one or more components associated with the HMD device for use. The hardware sensors include one or more eye tracking assemblies 472 of an eye tracking subsystem that are mounted on or near the display panels 406 and 408 and/or located on the interior surface 421 near the optical lens systems 410 and 412 for use in acquiring information regarding the actual locations of the user's pupils 494, such as separately for each pupil in this example.

Each of the eye tracking assemblies 472 may include one or more light sources (e.g., IR LEDs) and one or more light detectors (e.g., silicon photodiodes). Further, although only four total eye tracking assemblies 472 are shown in FIG. 4 for clarity, it should be appreciated that in practice a different number of eye tracking assemblies may be provided. In some embodiments, a total of eight eye tracking assemblies 472 are provided, four eye tracking assemblies for each eye of the user 424. Further, in some embodiments, each eye tracking assembly includes a light source directed at one of the user's 424 eyes 432 and 434, a light detector positioned to receive light reflected by the respective eye of the user, and a polarizer positioned and configured to prevent light that is reflected via specular reflection from being imparted on the light detector.

Information from the eye tracking assemblies 472 may be used to determine and track the user's gaze direction during use of the HMD device 405. Furthermore, in some embodiments, the HMD device 405 may include one or more internal motors 438 (or other movement mechanisms) that may be used to move 439 the alignment and/or other positioning (e.g., in the vertical, horizontal left-and-right and/or horizontal front-and-back directions) of one or more of the optical lens systems 410 and 412 and/or display panels 406 and 408 within the housing of the HMD device 405, such as to personalize or otherwise adjust the target pupil location of one or both of the near-to-eye display systems 402 and 404 to correspond to the actual locations of one or both of the pupils 494. Such motors 438 may be controlled by, for example, user manipulation of one or more controls 437 on the housing 414 and/or via user manipulation of one or more associated separate I/O controllers (not shown). In some embodiments the HMD device 405 may control the alignment and/or other positioning of the optical lens systems 410 and 412 and/or display panels 406 and 408 without such motors 438, such as by use of adjustable positioning mechanisms (e.g., screws, sliders, ratchets, etc.) that are manually changed by the user via use of the controls 437. While the motors 438 are illustrated in FIG. 4 for only one of the near-to-eye display systems, each near-to-eye display system may have its own one or more motors, and, in some embodiments, one or more motors may be used to control (e.g., independently) each of multiple near-to-eye display systems.

In some embodiments, other types of display systems may be used, including with a single optical lens and display device, or with multiple such optical lenses and display devices. Non-exclusive examples of other such devices include cameras, telescopes, microscopes, binoculars, spotting scopes, surveying scopes, etc. Additionally, a wide variety of display panels or other display devices that emit light to form images may be used, which one or more users view through one or more optical lens. In some embodiments, a user may view one or more images through one or more optical lenes that are produced in a manner other than via a display panel, such as on a surface that reflects light from another light source in part or in whole.

### Pixel Shifting for Increased Resolution

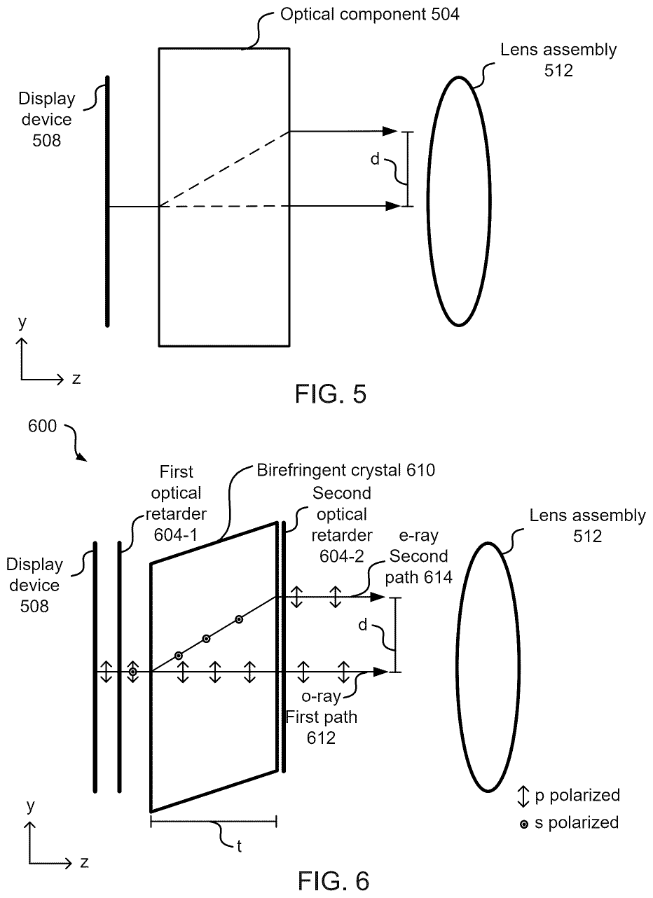

FIG. 5 depicts an embodiment of a system with an optical component 504 for shifting light from a display. The system comprises a display device 508 (e.g., display panel 406 from FIG. 4); a lens assembly 512 (e.g., optical lens assembly 410 in FIG. 4) arranged to focus light from the display device 504 to an eye of a user of the head-mounted display; and the optical component 504. The optical component 504, sometimes referred to as an optical shifter, is arranged to shift light from the display device 508 by a distance d, before the lens assembly 512. The distance d is equal to or greater than ½, ⅓, ¼, ⅕, ⅙, 1/7, or ⅛ of a pixel spacing in the display device 508 and/or equal to or less than 5/4, 1, ¾, or ½ of the pixel spacing.

By shifting light using the optical component 504 (e.g., by a half pixel), a resolution of the display device 508 can effectively be doubled. This can provide a higher fill factor (e.g., to fill in dead space) and/or remove or reduce things like column artifacts. For example, this can be used to wash out pixel structure (e.g., wash out the visibility of pixel structure), improve fill factor of pixels, improve visible mura (e.g., reduce mura of a display), and/or reduce the column artifacts of the display.

FIG. 6 depicts an embodiment of an optical shifter 602 in an optical system 600 for a head-mounted display. The optical system 600 comprises the display device 508 and the lens assembly 512 arranged to focus light from the display device 508 to an eye of the user of the head-mounted display. An optical component (e.g., an optical shifter) comprises a first optical retarder 604-1, a second optical retarder 605-2, and a birefringent element 610 (e.g., a birefringent crystal or polymer) between the first optical retarder 604-1 and the second optical retarder 604-2. The optical shifter is optically between the display device 508 and the lens assembly 512.

The optical shifter is electronically controlled. For example, the first optical retarder 604-1 and/or the second optical retarder 604-2 are adaptive molecular optics and/or a liquid crystal controllable to manipulate light. The optical retarders 604 can be electro-optic lenses. For example, electro-optic lenses are arranged to pass polarized light when not activated; and when the electro-optic lenses are activated, the electro-optic lenses act a half-waveplates to rotate polarization of light transmitted through the electro-optic lenses by 90 degrees. Thus, the optical shifter can be digitally controlled to manipulate light (e.g., by shifting the light). The electro-optic lenses have zero focusing power in this example. In some embodiments, the optical component comprises a piezo system.

As an example, while the optical shifter is not activated (e.g., optical retarders 604 are not activated), light travels along a first path 612 of an ordinary ray (o-ray) in FIG. 6. In the example in FIG. 6, light from the display device 508 is emitted in p polarization, passes through the first optical retarder 604-1 as p-polarized light, passes through the birefringent crystal 610 in a straight path from the display device 408, and passes through the second optical retarder 604-2 as p-polarized light to the lens assembly 512. Since the optical retarders 604 are not activated, they pass light without changing the polarization.

While the optical shifter is activated, the optical retarders act as halfwave plates, and light travels along a second path 614, a path of an extraordinary ray (e-ray) in FIG. 6. Light from the display device 508 is emitted in p polarization, passes through the first optical retarder 604-1 and is rotated by 90 degrees into s-polarized light, passes through the birefringent crystal 610 deviating at an angle from light emitted by the display device 508, and is rotated again by 90 degrees to p-polarized light as the light passes through the second optical retarder 604-2 to the lens assembly 512. Light traveling along the second path 614 (the path of the e-ray) is shifted from the path of the first path 612 (the path o-ray) by the distance d. A difference in thickness t of the birefringent element 610 can change an amount of shift (i.e., the distance d). For example, the thickness t of the birefringent element 610 is set so that the distance d is half a pixel width of the display device 508. Shifting light from the display 508 by a half a pixel (e.g., laterally shearing the image by half a pixel), effectively doubles resolution by putting light in a gap between pixels of the display device 508.

The optical component is synced with the display device 508. In some embodiments, the optical component activates (e.g., on or off) every frame of the display device 508, or faster or slower. For example, the optical retarders 604 in FIG. 6 are powered every other frame. Accordingly, if the display device 508 runs at a frame rate of 90 Hz, then light is transmitting along the o-ray path at 45 Hz and along the e-ray path at 45 Hz; if the frame rate of the display device 508 is 120 Hz, then the frame rate of the o-ray path and the frame rate of the e-ray would each be 60 Hz. In some configurations, different paths have different frame rates. For example, the optical retarders 604 in FIG. 6 can be turned on and remain on for 1, 2, 3, 4, or more frames before turning off, and/or the optical retarders 604 can remain off for 1, 2, 3, 4, or more frames before being turned on (e.g., depending on a frame rate of the display device).

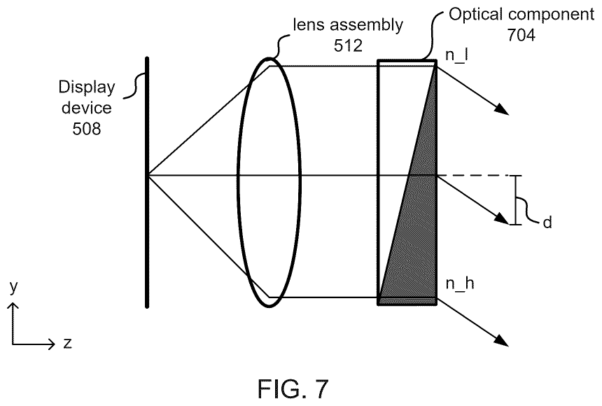

Shifting light from the display device 508 can be in an image plane or pupil plane. FIG. 7 depicts an embodiment of a system with an optical component 704 having a homogeneous refractive index while not powered (e.g., off) and a variable refractive index while powered (e.g., on), for shifting light in the pupil plane. The lens assembly 512 is optically between the optical component 704 and a display device 508. In some embodiments, the optical component comprises an adaptive molecular optic, a liquid crystal controllable lens, electronically activated lens, and/or digitally controlled lens. An adaptive liquid crystal lens can be electronically controlled to modify a refractive index of a medium. For example, an electric current can be used to rearrange liquid crystal molecules. After the electric current is turned off, the liquid crystal molecules return to their previous state.

In the embodiment in FIG. 7, the display device 508 is a projector (e.g., for an augmented-reality system). While the optical component 704 in FIG. 7 is powered on, a refractive index gradient is formed from a high index n_h to a low index n_1, which effectively simulates a wedge prism (e.g., to laterally shears the image by half a pixel). For example, the refractive index varies linearly from n_h to n_1. By activating the optical component in FIG. 7, an image is shifted in the pupil plane similarly to shifting the image in the image plane as shown in FIGS. 5 and 6. For example, the image is shifted by a distance d at an eye box of a head-mounted display.

In some embodiments, the variable refractive index is a variation of the refractive index of the optical component 704 in one or two dimensions (e.g., in y and/or x). In the embodiment in FIG. 7, the refractive index varies linearly in one dimension (the y dimension), but other functions can be used. The index can vary in one or two dimensions according to a smooth function, a step function, or a combination of both a smooth function and a step function (e.g., a tooth function).

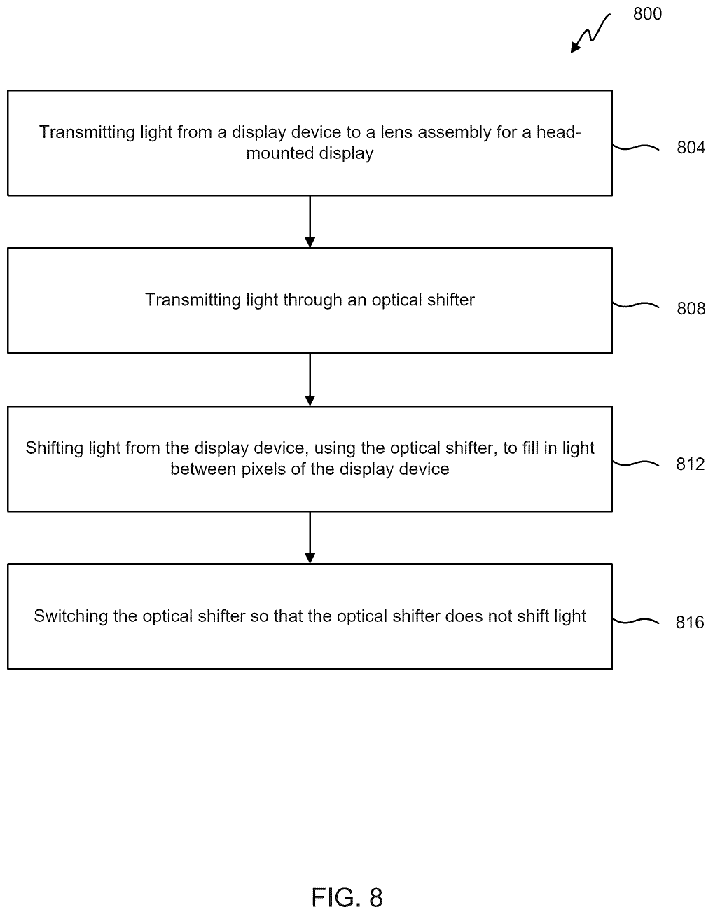

FIG. 8 depicts an embodiment of a process 800 for shifting light in a head-mounted display. Process 800 begins in step 804 with transmitting light from a display device to a lens assembly for a head-mounted display, the lens assembly arranged to focus light from the display device to an eye of a user of the head-mounted display. For example, light from display device 508 is emitted to lens assembly 512 in FIG. 6 or FIG. 7.

In step 808, light is transmitted through an optical shifter. For example, light is transmitted through optical element 504 in FIG. 5 or optical element 704 in FIG. 7.

In step 812, light from the display device is shifted, using the optical shifter, to fill in light between the pixels of the display device. In some embodiments, light is shifted by a distance equal to or greater than ⅕ of a pixel spacing in the display device and equal to or less than 5/4 of the pixel spacing. For example, light is shifted to travel along the second path 614 in FIG. 6 or angled downward as shown in FIG. 7.

In step 816, the optical shifter is switched so that the optical shifter does not shift light. Accordingly, light passes through the optical shifter without deviation. For example, the optical shifter is not activated (such as the optical retarders 604 in FIG. 6 or the optical component 704 in FIG. 7 are switched to an off state) and light travels the first path 612 in FIG. 6 or a path parallel to the z axis in FIG. 7.

In Some embodiments, the optical shifter is between the display device and the lens assembly (e.g., as described in FIGS. 5 and 6); the lens assembly is between the display device and the optical shifter (e.g., as described in FIG. 7); or light is transmitted though the shifter by light passing through a first half waveplate, then through a second halfwave plate, and then through a second half waveplate (e.g., as shown in FIG. 6).

### Pixel Shift Direction

Images (e.g., pixels in images) can be cleaned up. For example, a sharpening filter and/or a motion deblurring filter can be used. In some embodiments, pixel cleanup is weighted in a direction of pixel shift.

A display device presents a two-dimensional image in x and y dimensions, with x generally corresponding to a horizontal dimension and y corresponding to a vertical dimension, while a user of a head-mounted display is looking forward in a neutral position (i.e., with the user's head not “looking,” or tilted, up, down, or sideways).

If the optical shifter shifts light along just one axis (e.g., along just the x axis), then resolution will be increased in only one dimension (e.g., the horizontal dimension). Accordingly, in some embodiments, the optical shifter is configured to shift light in a direction of 45 degrees, plus or minus 5, 10, or 15 degrees, with respect to the x dimension and measured in the direction of the y dimension. Thus, instead of resolution being doubled in just x or just y, resolution is increased by a factor of about 1.5 both dimensions. In some configurations, the distance d is equal to half a pixel times the square root of 2, for shifting at 45 degrees.

Merely by way of example, an LCD screen has a plurality of pixels, with each pixel having a red (R), a green (G), and a blue (B) component. Pixel pitch of the LCD screen is between 15 and 50 microns, such as 21 microns. The RGB components are spaced along the x dimension (e.g., horizontally), so that each RGB component also has pitch (e.g., measured from center to center) equal to the pixel pitch of the LCD screen of 21 microns. Each component has an aperture, which is less than the pitch, and the aperture can be rectangular. For example, an aperture of the G component is 5 microns wide (i.e., horizontal) and 19 microns high (i.e., vertical). The aperture can be a polarization gate letting light through. A person skilled in the art will recognize that other dimensions can be used.

If the aperture for a component is rectangular and elongated in the vertical direction, there will be more overlap in the vertical direction than the horizontal direction for a 45-degree shift of light from the component. In some configurations, some overlap is good because sharpening can have better results with some overlap.

Though described in rectilinear coordinates, a person skilled in the art will understand the described concepts can apply to other displays than rectangular displays, such as curved displays.

### Rendering Camera Angle

A rendering camera is a virtual camera positioned within a 2D or 3D model used to generate an image from the model to present on the display device. In some configurations, as light from display device is shifted by the optical shifter, the angle of the rendering camera (i.e., the view angle) is also shifted (e.g., rotated). The angle of the rendering camera is shifted to render a shifted image more accurately. A shift in angle (e.g., rotational shift) corresponds to a shift in pixel (e.g., a translational shift). Thus, pose (e.g., view angle) of the rendering camera can be toggled synchronously with activation of the optical shifter, in some configurations. And images from different rendering angles can be interweaved and presented to the user.

In some embodiments, the amount of angle shift θ is calculated by the relationship:

$$θ = arctan ( d / ( focal length ) ) ,$$

where d is the distance d (e.g., in FIG. 5), and the focal length is the focal length of the rendering camera.

As an example, if the pixel shift (distance d) is 11 microns, and the camera focal length is 50 mm, then the view angle would be shifted by 0.013 degrees in the direction of the pixel shift.

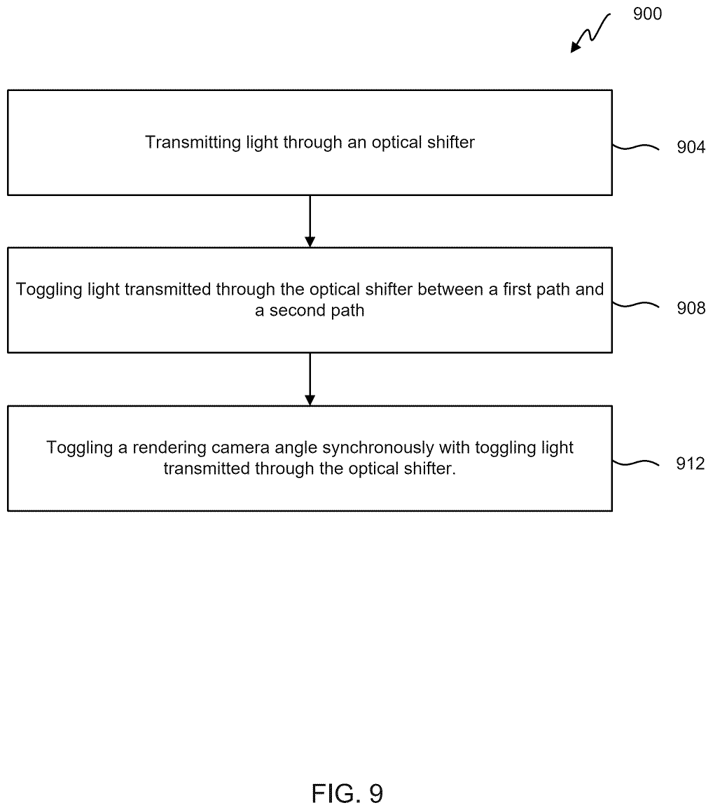

FIG. 9 depicts an embodiment of a process 900 for synchronizing camera angle with pixel shift. Process 900 begins in step 904 with transmitting light through an optical shifter. In step 908, light transmitted through the optical shifter is toggled between a first path and a second path. For example, light is toggled between the first path 612 and the second path 614 in FIG. 6 as the optical shifter is turned off and on. In step 912, a rendering camera angle is toggled synchronously with toggling light transmitted through the optical shifter (e.g., to render a shifted image more accurately).

As physical pixels are shifted by half a pixel, the render camera is shifted by half a pixel as well. But because a physical pixel moves in position by a half a pixel (e.g., by approximately 11 microns), the render camera converts the physical offset into angle shift in the render camera. For example, if the HMD lens has a focal length of 30 mm and one pixel is 0.021 mm, then one pixel can be converted into angle by theta=atan (0.021 mm/30 mm). Accordingly, one pixel is 0.0007 degrees. Half of that is 0.00035. Thus, the render camera would shift its angle by 0.00035 degrees.

The embodiments were chosen and described in order to explain the principles of the invention and practical applications to thereby enable others skilled in the art to best utilize the invention in various embodiments and with various modifications as are suited to the particular use contemplated.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc.

A recitation of “a”, “an”, or “the” is intended to mean “one or more” unless specifically indicated to the contrary.

All patents, patent applications, publications, and descriptions mentioned here are incorporated by reference in their entirety for all purposes. None is admitted to be prior art.

What is claimed is:

1. An apparatus comprising:
a display device;
a lens assembly for a head-mounted display, the lens assembly arranged to focus light from the display device to an eye of a user of the head-mounted display;
a birefringent element between the display device and the lens assembly; and
a half waveplate between the birefringent element and the lens assembly, wherein the half waveplate and the birefringent element are arranged to shift light from the display device by a distance equal to or greater than ⅕ of a pixel spacing in the display device and equal to or less than 5/4 of the pixel spacing.

2. The apparatus of claim 1, wherein the half waveplate is disposed on the birefringent element.

3. The apparatus of claim 1, wherein shifting light is arranged to reduce column artifacts of the display device.

4. The apparatus of claim 1, wherein the display device is a screen.

5. An apparatus for a head-mounted display comprising:
a display device;
a lens assembly arranged to focus light from the display device to an eye of a user of the head-mounted display; and
an optical component arranged to shift light from the display device by a distance equal to or greater than ⅕ of a pixel spacing in the display device and equal to or less than 5/4 of the pixel spacing.

6. The apparatus of claim 5, wherein the display device is a display panel or a projector.

7. The apparatus of claim 5, the optical component comprising:
an electronically activated optical retarder; and
a birefringent element between the electronically active optical retarder and the lens assembly.

8. The apparatus of claim 5, wherein the optical component is electronically controlled.

9. The apparatus of claim 8, wherein the optical component is synced with the display device.

10. The apparatus of claim 5, wherein the optical component is optically between the display device and the lens assembly.

11. The apparatus of claim 5, wherein the display device is a projector, and the lens assembly is optically between the display device and the optical component.

12. The apparatus of claim 5, wherein the optical component comprises an adaptive molecular optic.

13. The apparatus of claim 5, wherein the optical component comprises a liquid crystal controllable lens.

14. The apparatus of claim 5, wherein the distance shifted is at a 45-degree angle, plus or minus 10 degrees, with respect to a horizontal dimension of the display device.

15. The apparatus of claim 5, wherein a rendering camera angle is shifted in synchronization with shifting light from the display device.

16. The apparatus of claim 5, wherein the optical component has a variable refractive index.

17. A method for a head-mounted display comprising:
transmitting light from a display device to a lens assembly, the lens assembly arranged to focus light from the display device to an eye of a user of the head-mounted display;
transmitting light through an optical shifter; and
shifting light from the display device, using the optical shifter, by a distance equal to or greater than ⅕ of a pixel spacing in the display device and equal to or less than 5/4 of the pixel spacing.

18. The method of claim 17, further comprising switching the optical shifter so that light is transmitted through the optical shifter without deviation.

19. The method of claim 17, wherein light is transmitted though the optical shifter by light passing through a first half waveplate, then through a second halfwave plate, and then through a second half waveplate.

20. The method of claim 17, wherein:
light transmitted through the optical shifter is toggled between a first path and a second path; and
a rendering camera angle is toggled synchronously with toggling light transmitted through the optical shifter.
